(19) United States
(12) Patent Application Publication
(10) Pub. No.: US 2014/0081821 A1
(43) Pub. Date: Mar. 20, 2014

(54) INVENTORY MANAGEMENT SYSTEM

(71) Applicants: Kyle McCullough, Leon, IA (US); Sean Blomgren, Boone, IA (US)

(72) Inventors: Kyle McCullough, Leon, IA (US); Sean Blomgren, Boone, IA (US)

(21) Appl. No.: 13/958,179

(22) Filed: Aug. 2, 2013

Related U.S. Application Data
(62) Division of application No. 13/618,627, filed on Sep. 14, 2012.

(51) Int. Cl. G06Q 40/04

(52) U.S. Cl. CPC G06Q 40/04
USPC 705/37

(57) ABSTRACT

A method for managing inventories of commodities using a centralized inventory database to facilitate commodity trading. The method includes propagating the centralized inventory database with long and short inventory positions submitted by various dealers. Dealers use the centralized inventory database to locate long and short inventory positions of other dealers, coordinate commodity trades to offset their own long and short positions, and to adjust their own inventory positions to better address market forces.

### CROSS REFERENCE TO RELATED APPLICATIONS

This application is a divisional application of U.S. Ser. No. 13/618,627 filed Sep. 14, 2012, where is incorporated by reference herein.

### TECHNICAL FIELD

The disclosed embodiments relate generally to a method of inventory management and in particular to a method for using centralized inventory management to facilitate the trading of seed.

### BACKGROUND

At present seed dealers receive large allotments of the seeds, such as seed corn, from a producer. The allotment often comprises hundreds of bags of seed corn, with each bag containing seed corn of a single variety. As different varieties of seed corn have different yields, insect tolerance, disease resistance, etc. the allotment each dealer receives may include quantities of seed varieties the dealers do not need. The allotments may also be missing seed varieties the dealers require. Conventionally, if a dealer wishes to procure a particular type of seed variety the dealer would contact other dealers to determine if the other dealers had the particular seed varieties to trade. For particularly scarce types of seed varieties, a dealer may require a number of other seed varieties in exchange for the desired seed variety. This may require the original dealer to contact a plurality of dealers to initiate a multi-dealer trade in an effort to obtain a particular variety of seed. It is known for various district managers to keep notes as to which dealers may have an excess of particular seed varieties, known as a “long” positions, and which dealers are in need of particular varieties of seed, known as a “short” positions.

One drawback associated with handwritten notes is that the notes quickly become outdated. By the time a district manager is able to set up a multi-dealer trade for various varieties of seed, the dealers may have already sold or traded the seed, thereby preventing the trade from taking place. Another drawback associated with such handwritten notes is the inability to sort and search the notes for particular quantities and varieties of seed. Yet another drawback associated with the prior art is the inability of a regional manager to coordinate easily with other regional managers to facilitate multi-region trades to obtain desired seed varieties.

### SUMMARY OF THE DISCLOSED SUBJECT MATTER

A preferred embodiment of the present invention provides a method for managing commodities to facilitate the identification of advantageous trades. In one embodiment, a seller provides various types of seeds to a plurality of dealers. The dealers upload their long and short positions to a centralized database and the database presents the collective long and short positions of the dealers in a data grid available to the dealers. The data grid lists which varieties are available from which dealers and which dealers desire which varieties.

Once a dealer with a short position identifies a dealer with a long position in the desired seed variety, the dealer with the short position contacts the dealer with the long position to initiate a transfer of the seed variety from the dealer with the long position to the dealer with the short position. Once the transfer is completed, the dealers update the data grid to reflect the transaction. In a preferred embodiment, the seller notes the transfer and credits the transferring dealer for the amount of seed transferred and debits the account of the dealer receiving the seed in the amount of the transfer. Although numerous trades may take place over the course of a billing cycle, the seller only invoices the dealers for the net amount of the seed sold, not traded, by the dealer according to the data grid information.

Additional objects, advantages and novel features of the present invention are set forth in part in the following description and will become more readily apparent to those skilled in the art upon examination of this disclosure or may be taught through practice of the invention.

### BRIEF DESCRIPTION OF THE DRAWINGS

The present invention will now be described, by way of example, with reference to the accompanying drawings in which:

FIG. 1 is a block diagram of a system architecture in accordance with one embodiment;

FIG. 2 is a flowchart illustrating the commodity management system in accordance with one embodiment;

FIG. 3 is a block diagram of a dealer order;

FIG. 4 is a block diagram of a centralized a data grid;

FIG. 5 as a block diagram of a notification alert page; and

FIG. 6 is a block diagram of a message board page.

### DETAILED DESCRIPTION OF THE DRAWINGS

A commodity inventory management system (100) allows a seller to better optimize trades of a commodity between dealers. In the preferred embodiment the seller is a large seed corn producer, but the seller may be a seller of any commodity. The commodity is preferably a perishable agricultural commodity, such as seed corn, but may be any type of commodity. The to commodity may be a tangible non-perishable commodity, such as a vehicle or virtual commodities, such as downloadable content associated with video games.

The seller provides quantities of the commodity, such as the seed corn, to various dealers. The system (100) allows dealers to identify amongst themselves which seed corn they have too much of (otherwise known as being “long” on that commodity), and which seed corn they have too little of (otherwise known as being “short” on that commodity).

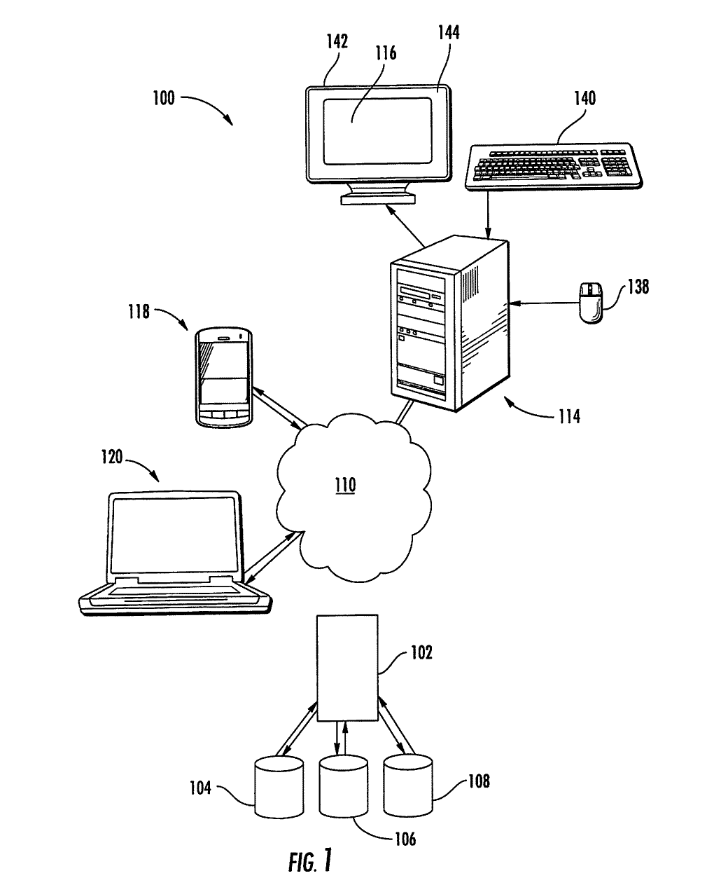

FIG. 1 is a block diagram of the architecture of the system (100) in accordance with one embodiment. As illustrated in FIG. 1, a server (102) associated with the seller is provided with a plurality of databases (104), (106) and (108). The server (102) is connected to a network (110). While in the preferred embodiment the network (110) is typically a global communications network, such as the Internet, the network (110) may be any network, including but no limited to, a LAN, a MAN, a WAN, a mobile wired or wireless network, a private network or a virtual private network.

When a dealer wishes to use the system (100), the dealer accesses the system website (112) via the network (110) and provides identifying information to create a dealer account. The system website (112) may be operated by the seller, a dealer or by a third party. As used herein, the term “website” means any system providing content but is not limited to those systems supporting content provided via the Internet or via http protocol. In general, functions described herein as being performed on the server side may also be formed on the client side as appropriate.

Alternatively, the dealer may provide the identifying information telephonically, via electronic mail, via facsimile or by any suitable method of communication. The dealer uses a client (114) to execute a browser that connects to the server (102) via the network (110). Although only three clients (114), (118) and (120) and one browser (116) are shown, it is to be understood that thousands of clients or more may be supported and can be in communication with the server (102) at any given time. If desired, multiple servers may be used.

The client (114) may include a variety of different computing devices. Examples of client devices are personal computers, personal digital systems, mobile telephones, smart phones, tablet devices and laptop computers. As would be obvious to one of ordinary skill in the art, the present invention is not limited to the foregoing devices.

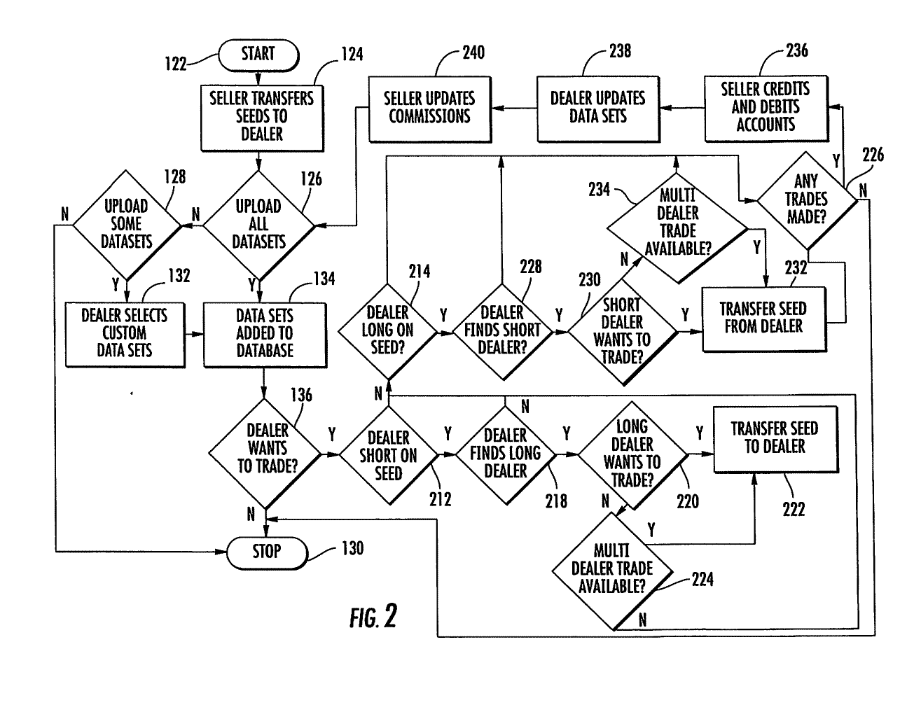

FIG. 2 is a flow diagram showing the steps typically performed by the system (100) to facilitate the transfer of commodities between dealers. The process begins at (122), with the first step (124) being the seller transferring a commodity, such as seeds, to various dealers. While the seeds may be provided to dealers in any manner known in the art, in the preferred embodiment the seed is allocated to the various dealers based upon predicted demand, seed availability, as well as various other factors. Given that growing conditions cannot be predicted with precise accuracy, the seller must often transfer bags of seeds to dealers that, due to weather conditions, disease, pests or the like, will either be in high demand or in low demand. As demand fluctuates by geographic region, and from farmer to farmer, dealers often end up with “long” positions on certain bags of seed, meaning the dealer ends up with certain types of seeds that the dealer does not anticipate selling. Dealers also often end up with “short” positions on other types of seeds, meaning the dealer anticipates the dealer would be able to sell more of this type of seed if the dealer had a sufficient quantity of the seed on hand. Often dealers may be long on one type of seed, while short on another. Given the differences in geography, weather conditions, disease, pests, personal preference, and the like, it is not unusual for one dealer to be long on the exact type of seed that another dealer is short on. It would be desirable, therefore, to match long position dealers with short position dealers, to increase efficiencies for the long position dealer, the short position dealer, the seller, and the end user.

As the dealers are typically independent contractors, the seller is often contractually bound not to publish the inventories of the various dealers, and cannot force the dealers to publish their inventories themselves. The present system (100) allows the dealers to upload inventory datasets to a centralized data location. Inventory datasets comprise at least two things: 1) a commodity type; and 2) a quantity associated with that commodity type. For instance, a dealer may have 84 bags of AR4692 seed corn in excess inventory. The dealer would, therefore, use the client (114) to upload the dataset of the quantity type (AR4692), and the excess quantity (84 bags), that the dealer has in inventory. The dealer uploads this inventory dataset to the server (102) that then stores the dataset in the database (104). Similarly, another dealer may upload a second dataset to the database (104), indicating that the dealer needs 52 bags of AR4692 seed corn. Matching these dealers would allow the first dealer to get rid of at least 52 bags of seed that are not selling, and would allow the second dealer to alleviate a shortage.

Dealers are often required to report to the seller all sales and transfers of seed corn. This reporting allows the seller to keep track of the total bags of seed sold by a particular dealer, so that the seller can periodically pay the dealer a bonus, such as a commission, for actually selling the seed. The seller also tracks the bags of seed shipped to the dealers. This allows the seller to cross-reference the number of bags shipped to the dealers with the number of bags sold or transferred to determine the dealers' current inventory. Preferably, the seller periodically forwards this inventory information to the dealers. The dealers may then use these use these reports to directly upload the dealers' inventory to a memory device, such as the database (104) associated with the server (102). Alternatively, as explained below, the dealers may authorize the seller to directly upload all or part of this inventory information directly to the database.

Once the dealer receives the updated inventory list from the seller, the dealer can decide whether the dealer wishes to upload the entire inventory to the database (104). If the dealer does not wish to upload the entire inventory list to the database (104), the dealer has the option (128) of uploading certain datasets of the inventory to the database (104). In the preferred embodiment, if the dealer does not upload any inventory to the database (104), the dealer is not allowed access to the system (100), and the routine finishes (130). Alternatively, the dealer may still be allowed to use the system (100), without uploading any inventory to the database (104), in which case the process moves to step (136) detailed below.

If the user does wish to upload some of the datasets, the dealer selects (132) the inventory datasets to upload to the database (104) that include both the seed type and a quantity associated with the seed type. The quantity may either be a positive quantity, indicating the dealer is long on the seed, or a negative quantity, indicating the dealer is short on the seed. If desired, the dealer may list quantities that do not accurately reflect the dealer's inventory. If the dealer has a particularly fast selling seed, the dealer may not wish to indicate that the dealer is long on that position and that the seed is available to other dealers. Similarly, the dealer may wish to list a deficit or “short” of a particular type of seed corn that the dealer is not actually currently in need of, if the dealer anticipates needing more of that seed corn in the future. The dealer may also list a smaller deficit of a particular type of seed corn if the dealer anticipates the deficit otherwise resolving itself.

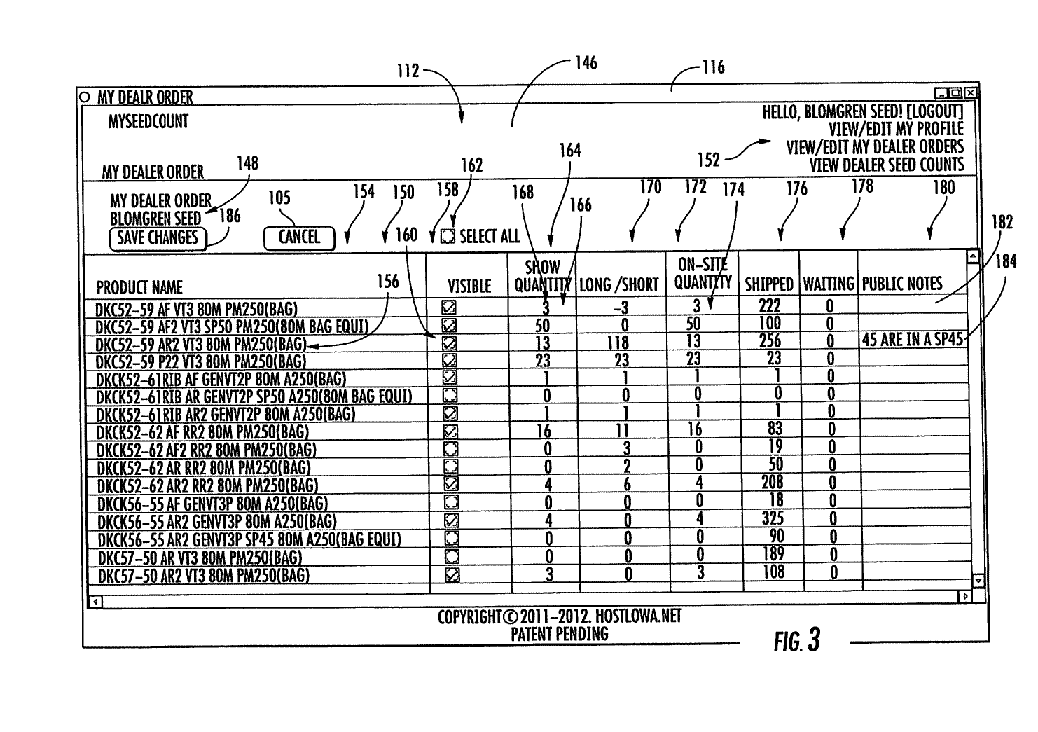

Once the dealer decides whether to upload (126) all of the dealer's inventory, or to select (132) a custom subset of the inventory to upload (126) to the database (104), the desired portion of the inventory is uploaded to database (104) in step (134). Once the dealer has inventory loaded on the database (104), the dealer may decide (136) to trade inventory with another dealer. Preferably, the dealer uses the client (114) to facilitate trading. As shown in FIG. 1, the client (114) is provided with various input devices, such as a mouse (138) and a keyboard (140). The client (114) is also provided with a video monitor (142) having a screen (144). Preferably, the dealer uses the client (114) to access the system website (112) stored on the database (106). The server (102) displays the system website (112) via a secure socket layer (SSL) or similar security protocol. The dealer may be required to enter a user name and password to access secure webpages associated with the system website (112), such as the dealer inventory page (146) shown in FIG. 3.

As shown in FIG. 3, the dealer inventory page (146) includes the name (148) of the dealer, a chart (150) and various hypertext links (152) to allow the dealer to view and/or edit various aspects of the dealer's account. The chart (150) has a first column (154) listing the names (156) of the types of seeds. The chart (150) has a column (158) with boxes (160) that allow the dealer to check whether the particular inventory dataset associated with that item should be displayed. The chart (150) is provided with a “select all” box (162) to allow the upload (126) of the dealer's entire inventory to the database (104).

As shown in FIG. 3, the dealer has only selected some of the boxes (160), choosing to upload (126) only some of the inventory to the database (104). The chart (150) also provides a “show quantity” column (164), providing fields (166) into which the dealer may input numbers (168) representing quantities associated with the names (156) of the commodity. As noted above, these numbers may, or may not, reflect the dealer's actual inventory. The chart (150) also provides a long/short column (170), listing the quantities representing the dealer's actual inventory. Preferably, this information is propagated to the chart (150) via inventory reports available to the dealer through the seller.

As shown in FIG. 3, the dealer may insert numbers into the fields (166) showing the quantity of the commodities being greater than or less than the dealer's actual inventory. The chart (150) is provided with an “on-site quantity” column (172), with a plurality of fields (174), which allow the dealer to insert a number representing the on-site quantity of the various commodities. As shown, the number inserted into this field may or may not represent the actual inventory the dealer has on-site. The chart (150) has a “shipped” column (176) representing the quantity of commodities actually transferred by the seller to the dealer and a “waiting” column (178) representing the quantity of each commodity that a customer desires but has not yet received. Finally, the chart (150) is provided with a “public notes” column (180) provided with a plurality of fields (182) associated with the name (156) of the commodities to allow the dealer to insert a notation (184) in the field (182) relating to the particular commodity. Once submitted, these notes will be available to other dealers using the system (100).

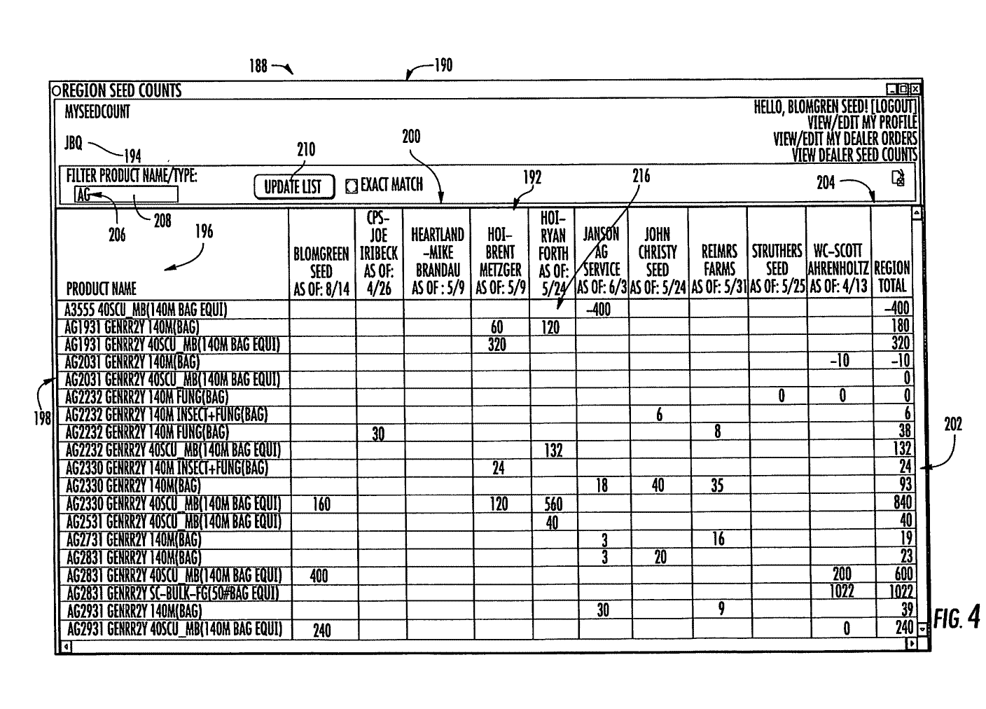

Once the dealer has filled out the chart (150) as desired, the dealer selects the “save changes” button (186), thereby uploading the datasets, and other information input into the chart (150), to the database (104). If the dealer does not wish to upload the datasets and other information to the database (104), the dealer selects the “cancel” button (105). Once the dealer selects the “save changes” button (186), the server (102) adds the datasets associated with the dealer to a centralized data grid shown generally as (188) in FIG. 4. The server displays the centralized data grid (188) on a webpage (190) associated with the system website (112). The webpage (190) is preferably encrypted, accessible only to those dealers submitting datasets to the database (104).

The centralized data grid (188) shows inventories for a plurality of dealers associated with a particular geographic region. The name (194) of the region is displayed on the webpage (190). The centralized data grid (188) has a first column (196) listing the commodity names (198). The centralized data grid (188) is also provided with a plurality of columns (200) associated with the dealers (192) and a plurality of rows (202) listing the quantity of the associated commodity submitted by the dealers (192). The centralized data grid (188) is also provided with a “region total” column (204) aggregating the total of the centralized data grid's (188) rows (202).

As shown in FIG. 2, if the dealer wants (136) to trade a particular commodity, the dealer may examine the centralized data grid (188) on the webpage (190), or may enter a search term (206) into the search field (208) and select the “update list” button (210). The search term (206) may be a complete designation of a particular commodity, or may be a partial designation of a particular commodity, in which case the server (102) returns a centralized data grid (188) listing all of the commodities that include the search term (206). The search may be restricted to only that region displayed on the webpage (190), or may search additional regions as well. Preferably, the dealer is only allowed to view the centralized data grid (188) associated with the dealer's own region, but the dealer is allowed to search additional regions if authorized by the system (100).

As shown in FIG. 2, if the dealer is not short on seed, the process moves to step (214). If the dealer is short (212) on seed, the dealer may enter a search term (206) into the search field (208) identifying the particular seed the dealer needs. The dealer then examines the search results displayed on the centralized data grid (188) to identify on the screen (144) a quantity (216) associated with the seed desired by the dealer.

If the dealer does not locate (218) the commodity desired, the process moves to step (214). If the dealer does locate (218) a quantity (216) of commodity desired, the dealer sends a request to the long dealer for a predetermined quantity of the commodity. Preferably the predetermined quantity requested is less than or equal to the amount by which the long dealer is long on that particular commodity. If the long dealer agrees (220) to provide the seed, the long dealer transfers (222) the predetermined quantity of the commodity to the dealer in response to the request sent by the dealer. If the long dealer does not agree (220) to provide the seed, the requesting dealer may conduct another search. If no dealers agree (220) to provide the needed seed, the dealer may search for a multi-dealer transfer, whereby a long dealer not wishing to transfer a particular commodity to the requesting dealer may transfer the commodity to the requesting dealer in exchange for a quantity of a different seed being sent by the requesting dealer to the long dealer. Alternatively, the requesting dealer may locate another long dealer with a long position on a type of seed desired by the original long dealer. The requesting dealer may then be able to organize (224) a multi-dealer transfer, and the process moves to step (222), where the commodities are exchanged between multiple dealers and the desired seed is transferred to the requesting dealer. Once the commodity has been transferred, the process moves to step (214). If the requesting dealer is not able to arrange a multi-dealer transfer (224), the process also moves to step (214), without a transfer (222) being made.

If the dealer is not long (214) on any seed, the process moves to step (226). If the dealer is long (214) on seed and wishes to transfer seed, the process moves to (228) where the dealer searches for a dealer short on the commodity that the dealer has in excess. If the dealer is unable to find a dealer short on the desired commodity, the process moves to (226). If the dealer is able to find a dealer short on the desired quantity, either by providing a search term (206) into the search field (208), or otherwise, the process moves to (230) where in response to identifying the short dealer, the dealer sends a request to the short dealer to determine if the short dealer wishes to make a trade. If the short dealer does wish (230) to make a trade, the process moves to (232) where the dealer transfers the excess seed to the short dealer. If the short dealer does not wish to make a trade, the process moves to (234), where the dealer may try to arrange a multi-dealer trade to transfer the excess seed. If the dealer is capable of arranging (234) the multi-dealer trade, the dealer transfers (232) the excess seed to one or more dealers in the multi-dealer trade. The amount of the transfer may be more than, less than, or equal to the quantity listed by the requesting dealer on the centralized data grid (188), but is preferably the quantity of seed agreed to between the dealer, the short dealer and any other dealers involved in the trade. If the dealer is not able to arrange (234) a multi-dealer trade, the process moves to (226). If the dealer is able to arrange (234) a multi-dealer trade, and the seed is transferred (232), the process also moves to (226).

If no trades were made, the process moves (226) to step (130) and the routine finishes. If trades (226) were made, the seller credits and debits (236) the dealer's internal account with the seller, so that the seller may properly invoice the dealer for seed actually in its possession. In step (236) the seller debits the dealer's internal account with seller for the amount of seed received from other dealers and credits the dealer's internal account for the quantity of seed transferred from the dealer to other dealers. Periodically, the seller will invoice the dealers. By keeping the dealers' accounts properly credited and debited for seed transferred to or from dealers, the dealers are only invoiced for that seed actually sold or in the dealer's possession. The process moves to step (238) where the dealer updates the dealer inventory page (146). The dealer may either directly update the page by adding numbers (168) into the show quantity column (164), or may upload a fresh inventory report directly from seller, thereby causing the long/short column (170) to repopulate with current figures.

The process then moves to step (240), where the seller recalculates and updates any commission attributable to the dealer. Commissions are funds paid periodically by the seller to the dealer for seed actually sold. If seed originally provided to the dealer is not sold or is transferred to another dealer, the dealer's prospective commission account is debited in an amount equal to the amount of seed not sold or transferred. Similarly, if a dealer receives seed from another dealer and sells that seed, the seller credits the dealer's prospective commission account for the quantity of seed transferred and sold, so that commissions are paid from the seller to the dealers. The commissions correctly reflect the net seed actually sold by the dealers. No commissions are paid on seed merely transferred to other dealers.

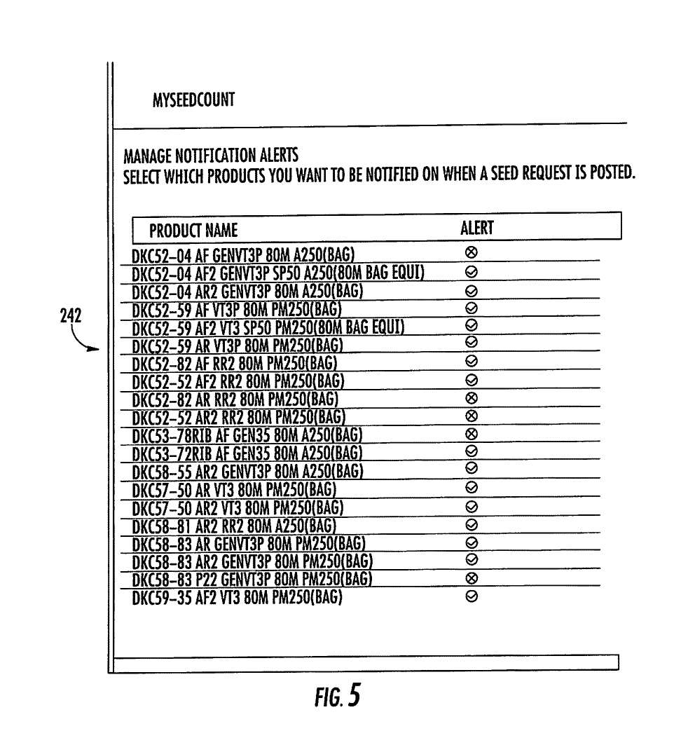

As shown in FIG. 5, the system website (112) also provides a manage notification alerts webpage (242). As shown, the webpage (242) allows the dealer to select various commodities in which the dealer is interested. The dealer selects the desired commodities and indicates whether the dealer is interested in being alerted to long positions in the commodity, short positions in the commodity, changes in the overall demand for the commodity, etc. The dealer then elects to have the system (100) send alerts to the dealer, via email, text or other alert process known in the art. The alert may provide any desired detail, including whether another dealer is long or short on the commodity.

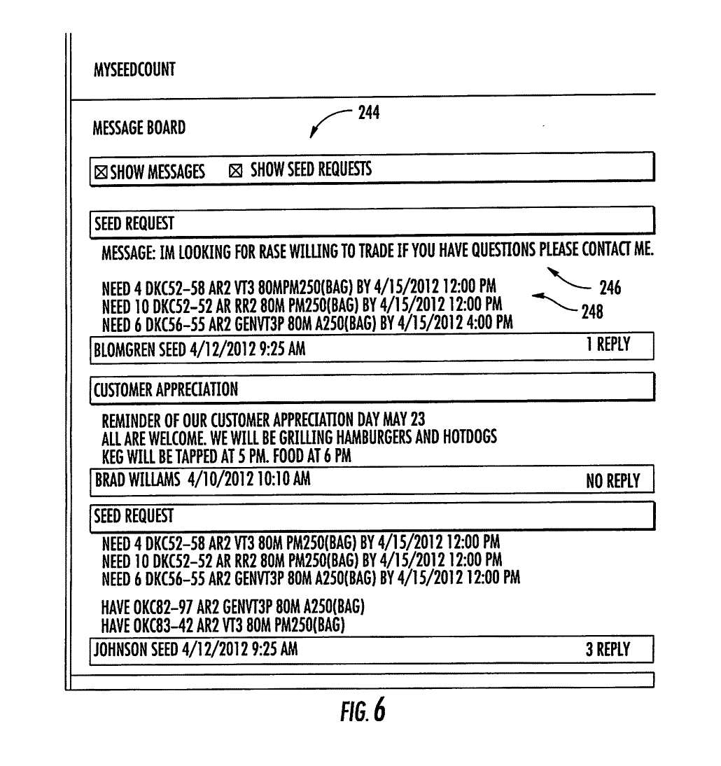

As shown in FIG. 6, the system website (112) is also provided with a message board (244) that allows the dealer to post messages (246) and receive responses (248) regarding commodities, including the dealer's long and short positions on various commodities.

Although the invention has been described with respect to a preferred embodiment thereof, it is to be understood that it is not to be so limited since changes and modifications can be made therein which are within the full, intended scope of this invention as defined by the appended claims.

What is claimed is:

1. A computer implemented method of trading a commodity comprising:
(a) providing a first dataset associated with a first dealer comprising:
(i) a commodity type; and
(ii) along position associated with the commodity type;
(b) providing a second dataset associated with a second dealer comprising:
(i) the commodity type; and
(ii) a short position associated with the commodity type;
(c) providing a database;
(d) uploading the first dataset to the database over a global communication network;
(e) uploading the second dataset to the database over a global communication network;
(f) identifying the long position corresponding to at least a portion of the short position;
(g) in response to identifying the long position corresponding to the short position, sending a request for a transfer of a predetermined amount of the commodity from the first dealer to the second dealer;
(h) in response to sending the request, transferring the predetermined quantity of the commodity from the first dealer to the second dealer;
(i) updating the long position to reflect the subtraction of the predetermined quantity; and
(j) updating the short position to reflect the addition of the predetermined quantity paragraph.

2. The computer implemented method of trading a commodity of claim 1, further comprising:
(a) providing a third dataset associated with a third dealer, comprising:
(i) the commodity type; and
(ii) supplemental long position associated with the commodity type;
(b) identifying the supplemental long position corresponding to at least a portion of the short position;
(c) in response to identifying the supplemental long position, sending a supplemental request for the transfer of a supplemental predetermined amount of the commodity from the third distributor to the second distributor;
(d) in response to sending the supplemental request, transferring the supplemental predetermined amount of the commodity from the third distributor to the second distributor;
(e) updating the supplemental long position to reflect the subtraction of the supplemental predetermined quantity; and
(f) updating the short position to reflect the addition of the supplemental predetermined quantity.

3. The computer implemented method of trading a commodity of claim 1, wherein the database is associated with a seller.

4. The computer implemented method of trading a commodity of claim 1, further comprising:
(a) providing a master account comprising:
(i) a first account debited an amount associated with the long position;
(ii) a second account;
(b) crediting the first account an amount correlated with the predetermined quantity of the commodity; and
(c) debiting the second account an amount associated with the predetermined quantity of the commodity

5. The computer implemented method of trading a commodity of claim 4, further comprising:
(a) invoicing the first dealer an amount comprising the amount of the first account;
(b) transferring from the first dealer to the seller an amount comprising the amount; of the first account;
(c) invoicing the second dealer and amount comprising the amount of the second account; and
(d) transferring from the second dealer to the seller and amount comprising the amount of the second account.

6. The computer implemented method of trading a commodity of claim 4, further comprising:
(a) crediting the first account an amount associated with the long position minus the predetermined quantity of the commodity; and
(b) crediting the second account an amount associated with the predetermined quantity of the commodity.

7. A computer implemented method of trading a commodity comprising:
(a) providing a database;
(b) propagating the database with:
(i) a plurality of long commodity positions associated with a plurality of dealers;
(ii) a plurality of short commodity positions associated with the plurality of dealers;
(c) sending a search request to the database to locate a long commodity position on a predetermined commodity;
(d) in response to sending the search request, identifying a long commodity position on the predetermined commodity;
(e) in response to identifying the long commodity position, sending a transfer request for the transfer of a predetermined amount of the commodity from a dealer with the long commodity position to a dealer with a short commodity position;
(f) in response to sending the transfer request, transferring the predetermined quantity of the commodity from the dealer with the long commodity position to the dealer with the short commodity position;
(g) updating the long commodity position to reflect the subtraction of the predetermined quantity of the commodity; and
(h) updating the short commodity position to reflect the addition of the predetermined quantity of the commodity;

8. The computer implemented method of trading a commodity of claim 7, wherein the search request comprises a search request to the database to locate a predetermined commodity position on a predetermined commodity within a predetermined geographical area.

9. The computer implemented method of trading a commodity of claim 7, further comprising:
(a) providing a master account comprising:
(i) first account debited an amount associated with the long commodity position;
(ii) a second account;
(b) crediting the first account an amount associated with the predetermined quantity of the commodity; and
(c) debiting the second account an amount associated with the predetermined quantity of the commodity.
